(19) United States
(12) Patent Application Publication
(10) Pub. No.: US 2020/0387869 A1
(43) Pub. Date: Dec. 10, 2020

(54) DELIVERY SYSTEM, DELIVERY MANAGEMENT SYSTEM, DELIVERY MANAGEMENT DEVICE, AND DELIVERY MANAGEMENT METHOD

(71) Applicant: UNIVERSITY-INDUSTRY COOPERATION GROUP OF KYUNG HEE UNIVERSITY, Yongin-si (KR)

(72) Inventors: Choong Seon HONG, Yongin-si (KR); Thar KYI, Yongin-si (KR)

(73) Assignee: UNIVERSITY-INDUSTRY COOPERATION GROUP OF KYUNG HEE UNIVERSITY, Yongin-si (KR)

(21) Appl. No.: 17/002,424

(22) Filed: Aug. 25, 2020

Related U.S. Application Data
(63) Continuation of application No. PCT/KR2018/013811, filed on Nov. 13, 2018.

(30) Foreign Application Priority Data
Nov. 13, 2018 (KR) 10-2018-0138915

(51) Int. Cl. G06Q 10/08; G06F 16/27; G06N 20/00

(52) U.S. Cl. CPC G06Q 10/08355; G06N 20/00; G06F 16/27

(57) ABSTRACT

The present invention relates to a delivery system, a delivery management system, a delivery management device, and a delivery management method, wherein the delivery system may comprise: a plurality of deliverer terminals corresponding to a plurality of deliverers, respectively; and a delivery management system which collects information required for delivery, and combines at least one of the plurality of deliverers on the basis of the information required for delivery to thereby determine an optimal route by which to deliver a parcel.

### CROSS-REFERENCE TO RELATED APPLICATIONS

The present application is a continuation of International Patent Application No. PCT/KR2018/013811, filed on Nov. 13, 2018, which is based upon and claims the benefit of priority to Korean Patent Application No. 10-2018-0138915, filed on Nov. 13, 2018. The disclosures of the above-listed applications are hereby incorporated by reference herein in their entirety.

### TECHNICAL FIELD

At least example embodiment relates to a delivery system, a delivery management system, a delivery management device, and a delivery management method.

### RELATED ART

Conventionally, it was general for buyers and sellers to trade goods with each other in the same area. In the recent times, there are many cases in which buyers and sellers conduct transactions in remote locations due to various reasons, such as the development of information and communication technology, activation of Internet transactions, the development of various sales media such as home shopping, and expansion of residence and business areas. Therefore, various types of delivery services are provided to move products between sellers and buyers present at remote locations. However, delivery services, such as a home delivery service, use a large amount of time for delivery. For example, a product purchased online uses at least two days on average. Accordingly, if urgent delivery is required, goods may be delivered using another method, which may require a customer to pay a considerable amount of cost.

Meanwhile, a smart city refers to a city that may manage assets and resources in an area and also may change and improve the life and environment in the area by acquiring a variety of data from various types of sensors present in a specific area and by processing the acquired variety of data using information and communication technology. The smart city may improve living standards of citizens by providing various types of smart services to the citizens present in the city. Also, the smart city requires a smart delivery service suitable for the smart city for smooth distribution of logistics inside and outside the smart city. However, only with the delivery service at a present time, it is very difficult to achieve a delivery service having a level of efficiency and suitability required by the smart city.

### DETAILED DESCRIPTION

### Technical Subject

An aspect of the present disclosure is to provide a delivery system, a delivery management system, a delivery management device, and a delivery management method that may reduce or minimize delivery cost and/or an amount of time (hereinafter, a delivery time) required for delivery by performing efficient delivery.

### Technical Solution

To outperform the aforementioned object, provided are a delivery system, a delivery management system, a delivery management device, and a delivery management method.

A delivery system may include a plurality of deliverer terminals corresponding to a plurality of deliverers, respectively; and a delivery management system configured to collect information required for delivery and to determine an optimal route by which a delivery item is to be delivered by combining at least one deliverer among the plurality of deliverers based on the information required for delivery.

The delivery management system may be configured to transmit a delivery instruction to at least one of the plurality of deliverer terminals according to the optimal route.

The information required for delivery may include at least one of information about a sender, information about a recipient, and information about the plurality of deliverers, and environmental information related to delivery.

The delivery management system may be configured to determine the optimal route based on a predicted traffic condition using a machine learning process.

The delivery management system may be configured to make a payment for the at least one deliverer.

The delivery management system may be configured to determine cost for the at least one deliverer using a blockchain-based smart contract.

The delivery management system may be configured to distribute a delivery route between deliverers using a crowdsourcing model.

The delivery system may further include at least one of a terminal of a sender configured to send a delivery item; a terminal of a recipient configured to receive the delivery item; and an electronic trading (e-trading) system configured to connect to at least one of the terminal of the sender and the terminal of the recipient and to determine a delivery item to be delivered by the deliverer.

The delivery management system may include one or at least two delivery management devices.

A delivery management system may include an information collection and processing unit configured to collect information required for delivery in volume; a deliverer management unit configured to manage a plurality of deliverers; and a delivery route management unit configured to determine an optimal delivery route by combining at least one deliverer among the plurality of deliverers based on the information collected by the information collection and processing unit.

The delivery management system may further include a cost processing unit configured to determine cost to be paid to each of at least one deliverer included in the delivery route.

The cost processing unit may be configured to determine cost to be paid to the at least one deliverer using a blockchain-based smart contract.

The delivery route management unit may be configured to determine an optimal route based on a predicted traffic condition using a machine learning process.

The deliverer management unit may be configured to distribute, to at least one deliverer, a delivery according to an optimal route using a crowdsourcing method.

The deliverer management unit may be configured to process a payment according to delivery to the deliverer in response to receiving a signal about a delivery work completion from a terminal of the deliverer.

A delivery management device may include an information collection and processing unit configured to collect information required for delivery in volume; a deliverer management unit configured to manage a plurality of deliverers; and a delivery route management unit configured to determine an optimal delivery route by combining at least one deliverer among the plurality of deliverers.

A delivery management method may include receiving a delivery request; deriving an optimal delivery route in response to the delivery request; distributing a delivery route to at least one deliverer according to the derived optimal delivery route; and transferring a delivery instruction to a terminal of the at least one deliverer.

The deriving of the optimal delivery route in response to the delivery request may include predicting a traffic condition using a machine learning process; and determining an optimal route based on the predicted traffic condition.

The delivery management method may further include making a payment for the at least one deliverer.

The delivery management method may further include determining cost for the at least one deliverer using a blockchain-based smart contract.

### Effect

According to the aforementioned delivery system, delivery management system, delivery management device, and delivery management method, it is possible to perform efficient delivery by reducing or minimizing delivery cost and/or delivery time.

According to the aforementioned delivery system, delivery management system, delivery management device, and delivery management method, it is possible to appropriately determine a number of participating deliverers and a delivery method by deriving and managing an optimal delivery route through artificial intelligence (AI) based on bigdata in real time.

According to the aforementioned delivery system, delivery management system, delivery management device, and delivery management method, it is possible to automatically determine and process a contract with a deliverer and implementation thereof at high reliability using a blockchain-based smart contract.

According to the aforementioned delivery system, delivery management system, delivery management device, and delivery management method, it is possible to improve the quality of the overall delivery service by allowing a deliverer to further aggressively participate in a transportation/delivery process using a crowdsourcing method.

According to the aforementioned delivery system, delivery management system, delivery management device, and delivery management method, it is possible to improve the convenience and satisfaction of all suppliers and consumers as well as distributors (delivers, etc.) with the intelligent delivery/shipment service.

### BRIEF DESCRIPTION OF DRAWINGS

FIG. 1 is a conceptual diagram illustrating an example embodiment of a delivery system.

FIG. 2 is a block diagram illustrating an example embodiment of a delivery management device.

FIG. 3 is a first diagram describing a process of determining a delivery route by a delivery management system.

FIG. 4 is a second diagram illustrating describing a process of determining a delivery route by a delivery management system.

FIG. 5 is a first diagram illustrating an example embodiment of a delivery route determined by a delivery management system.

FIG. 6 is a second diagram illustrating an example embodiment of a delivery route determined by a delivery management system.

FIG. 7 is a flowchart illustrating an example embodiment of a delivery management method.

### MODE

Hereinafter, unless the context clearly indicates otherwise, like reference numerals refer to like elements used throughout. Also, components used herein, such as, for example, terms “-unit/module,” etc., may be implemented as software or hardware. Depending on example embodiments, each component with “-unit/module,” etc., may be implemented as a single part, and also may be implemented as a plurality of pieces of parts.

When it is described that a single portion is connected to another portion throughout the present specification, it may indicate that a single portion is physically connected or electrically connected to the other portion. Also, when a single portion is described to include the other portion, it may include still another portion instead of excluding still other portion, unless the context clearly indicates otherwise.

Terms, such as first, second, and the like, may be used herein to describe components. Each of these terminologies is not used to define an essence, order or sequence of a corresponding component but used merely to distinguish the corresponding component from other component(s). Also, the singular forms “a,” “an,” and “the” are intended to include the plural forms as well, unless the context clearly indicates otherwise.

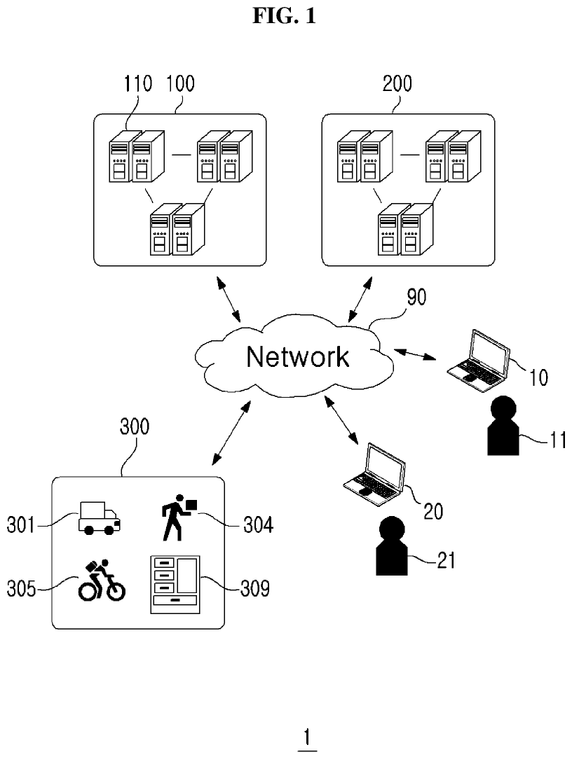

Hereinafter, example embodiments of a delivery system, a delivery management system, and a delivery management device are described in detail with reference to FIGS. 1 to 6.

FIG. 1 is a conceptual diagram illustrating an example embodiment of a delivery system.

A delivery system 1 refers to a set of devices, facilities, means, methods, laws, organizations, institutions, and/or other conforming things configured to deliver goods (Hereinafter, a delivery item) that a sender 11 desires to transfer from the sender 11 to a recipient 21. Here, the sender 11 includes, for example, a person who sends goods, such as a product seller, and the recipient 21 includes, for example, a person who receives the goods, such as a buyer. Also, delivery may be represented as transfer, transmission, or shipment and may include various actions performed in accordance therewith or in addition thereto.

The delivery system 1 may be implemented using a physical action (e.g., a transfer of goods between a person and a person) and/or a logical system (determination of a delivery route, determination of a deliverer, or payment processing for delivery) related to delivery.

The delivery item may refer to goods to be delivered by the delivery system 1 and may include various goods, for example, a product, cash, a gift certificate, and/or a mail. Here, the product may be goods to be sold or donated and may be a new product or a used product. The delivery item may be delivered in a form of a package by a container or packaging, but is not limited thereto.

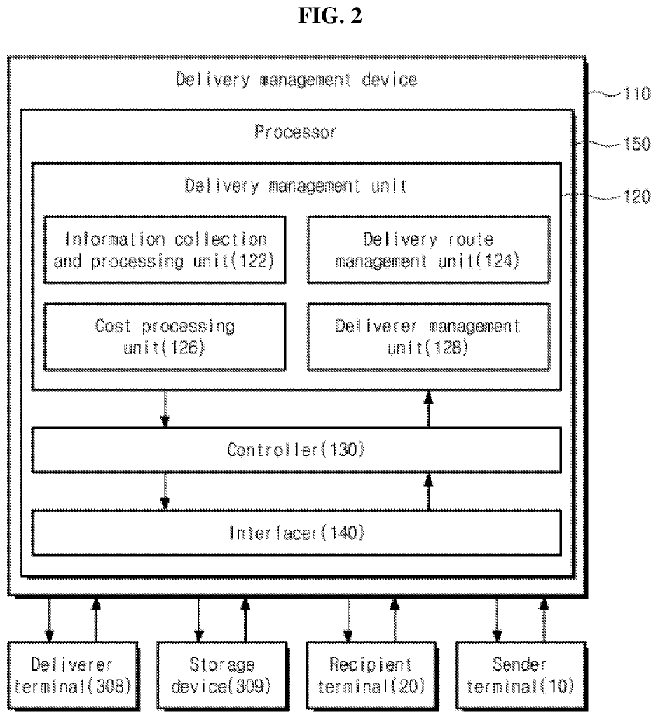

Referring to FIG. 1, a delivery system 1 may include a delivery management system 100 and terminals (308 of FIG. 2) of deliverers 300 (301, 304, 305) included in a single set. Depending on necessity, the delivery system 1 may further include at least one of a storage device 309, a terminal 10 of the sender 11, a terminal 20 of the recipient 21, and an electronic trading (e-trading) system 200.

The delivery management system 100 is provided to manage the overall process about delivery of a delivery item. For example, the delivery management system 100 may perform various types of operations, such as collecting a variety of information required for delivery, determining an optimal delivery route among a plurality of delivery routes, managing a delivery process, initiating the delivery or verifying whether the recipient 21 has received the delivery item, and/or payment according to a delivery contract and delivery completion with the individual deliverers 300 (301, 304, 305, 309).

The delivery management system 100 may include a delivery management device 110. The delivery management device 110 may be implemented using an information processing device capable of performing computational processing, such as, for example, a server computing device. The delivery management system 100 may include a single delivery management device 110 or may include at least two delivery management devices 100. If the delivery management system 100 includes the at least two delivery management devices 110, the at least two delivery management devices 110 may be interconnect or may communicate with each other through an intranet, an Internet network, and the like, such that the delivery management system 100 may perform various types of operations related to delivery management. Hereinafter, the delivery management device 100 is further described.

The delivery management system 100 may communicate with terminals (308 of FIG. 2) of the deliverers 300 (301, 304, 305, 309) included in a single set over a network 90. Also, if necessary, the delivery management system 100 may communicate with at least one of the terminal 10 of the sender 11 and the terminal 20 of the recipient 21 over the network 90.

The network 90 may be constructed through a wired communication network, a wireless communication network, or a combination thereof. Here, the wired communication network may be constructed using a cable. The cable may be implemented using, for example, a pair cable, a coaxial cable, an optical fiber cable, an Ethernet cable, and the like. The wireless communication network may be implemented using at least one of a near field communication network and a far field communication network. Here, the near field communication network may be implemented using, for example, wireless fidelity (Wi-Fi), Wi-Fi Direct, ZigBee, Bluetooth, Bluetooth low energy (BLE), controller area network (CAN) communication, and/or near field communication (NFC). The far field communication network may be implemented based on the wired communication network, for example, a mobile communication standard, such as, for example, 3rd Generation Partnership Project (3GPP), 3GPP2 and/or World Interoperability for Microwave Access (WiMAX) series.

The deliverer 300 serves to physically deliver a delivery item or to temporarily/non-temporarily store the delivery item for delivery. In detail, the deliverer 300 may include a vehicle 301 (e.g., which may include a truck, taxi, a passenger car, a train, and/or a two-wheeled vehicle and may also include an autonomous vehicle) capable of driving on the road, a walking deliverer 304 that delivers a delivery item on foot, and/or a bike deliverer 305 that delivers a delivery item using a bicycle. The deliverer 300 may include a ship, an aircraft (which may include a helicopter), and the like. Also, the deliverer 300 may further include the storage device 309 configured to temporarily or non-temporarily store the delivery item. However, the deliverer 300 is not limited thereto. The deliverer 300 may include various types of devices or persons capable of participating in delivery.

The deliverer 300 may be a device owned by a single specific or at least two logistics companies or an individual belonging thereto, or may be a device not owned thereby or an individual not belonging thereto.

The deliverer 300 may hold a terminal 308 for connecting the deliverer 300 and the delivery management system 100. The terminal 308 of the deliverer 300 may perform various actions, such as, for example, receiving a delivery instruction or receiving a variety of information required for delivery from the delivery management system 100 and providing the same to the deliverer 300, and/or transmitting information about delivery completion to the delivery management system 100.

Such the terminal 308 of the deliverer 300 may communicate with an outside and may include an electronic device capable of performing self-operation/processing. For example, the terminal 308 of the deliverer 300 may include at least one of a smartphone, a tablet PC, a smart watch, a cellular phone, a desktop computer, a laptop computer, a head mounted display (HMD) device, a digital TV, a set-top box, home appliance (e.g., a refrigerator, a washing machine, etc.) with Internet of Things (IoT) technology, a personal digital assistant (PDA), a navigation device, a vehicle autonomously embedded with a communication module and a processor (e.g., an electronic controlling unit (ECU)) for operation processing, a personal game console, an electronic billboard, an artificial intelligence (AI) sound playback device, an automated teller machine (ATM), and other various electronic devices that may be used substantially the same (hereinafter, such terminal devices are inclusively referred to as a smartphone, a desktop computer, etc.).

In detail, if the deliverer 300 is the vehicle 301, the terminal 308 of the deliverer 300 may be a navigation device installed in the vehicle 301, or may be the vehicle 301 itself in which the communication module and the ECU are installed. Also, if the deliverer 300 is the walking deliverer 304 or the bike deliverer 305, the deliverer terminal 308 may be one or at least two mobile devices (e.g., a tablet PC, a smartphone, etc.) owned by the walking deliverer 304 or the bike deliverer 305.

The storage device 309 refers to a device capable of temporarily or non-temporarily storing a delivery item. For example, the storage device 309 may be a smart locker. The sender 100 or the deliverer 300 may place a delivery item into the storage device 309 such that the deliverer 300 or another deliverer 300 may perform the delivery. Also, the deliverer 300 or the recipient 21 may receive the delivery item of the storage device 309. The deliverer 300 that receives the delivery item from the storage device 309 delivers the received delivery item. If the recipient 21 receives the delivery item, the delivery is completed.

According to an example embodiment, the storage device 309 may include a space in which a delivery item is placed, a door formed on the front or the top of the space, and a locking device provided to the door.

Also, the storage device 309 may further include a communication module (e.g., a communication chip, a communication terminal, and/or an antenna) configured to communicate with an external device (110, etc.), a processor configured to manage/control the overall operation of the storage device 309 and a sensor configured to determine whether the delivery item is placed inside. In this case, the storage device 309 may detect a placement status of the delivery item, may acquire information related to the delivery item (e.g., a password of a locking device, a placed time, a weight of the delivery item, and a reception time, etc.), and then may transfer the acquired information to the delivery management system 100 through the communication module. The delivery management system 100 may manage delivery and/or determine whether the delivery is being appropriately performed based on information transferred from the storage device 309. For example, the delivery management system 100 may receive storage initiation of the delivery item and information related thereto and may sequentially transfer the information to the next deliverer 300 such that the next deliverer 300 may receive the delivery item from the storage device 309 or may verify a delivery completion status.

The e-trading system 200 serves to connect to the terminal 10 of the sender 11 and the terminal 20 of the recipient 21 and to interconnect the sender 11 and the recipient 21. For example, the e-trading system 200 may receive information about goods (e.g., goods to be sold) to be transferred from the sender terminal 10 and to transfer the same to the connected recipient terminal 20, thereby supporting the recipient 21 to determine goods (e.g., goods to purchase) to be delivered. Therefore, the delivery item to be delivered under management of the delivery management system 100 may be determined.

The e-trading system 200 may include, for example, an online sales site, an online marketplace system, a purchasing agency system, a management system of a logistics company, a delivery brokage system, an Internet café, and/or a messenger system between individual persons, and may also include various types of systems provided to deliver a delivery item.

The e-trading system 200 may communicate with the delivery management system 100 over the network 90. In this case, an application programming interface (API) may be employed for connection between the delivery management system 100 and the e-trading system 200. The e-trading system 200 may transfer information about the delivery item itself and information related thereto to the delivery management system 100, such that the delivery management system 100 may overall manage delivery of the delivery item. Here, the information about the delivery item itself may include an article, an appearance, a shape, a size, a weight, a damage easiness level, and/or whether of a dangerous article in relation to the delivery item. The information about the delivery itself may include, for example, a sending location, a reception location, and/or an emergency status.

The terminal 10 of the sender 11, that is, the sender terminal 10 may connect to at least one of the delivery management system 100 and the e-trading system 200 over a communication network, and may transmit, to the systems 100 and 200, an instruction, a request, or information input from or preset by the sender 11. For example, the sender terminal 10 may transmit a delivery request for a delivery item to the delivery management system 100 and may transmit information about a product desired to be sold to the e-trading system 200. If the information about the product desired to be sold is transmitted to the e-trading system 200, the delivery request may be transmitted from the sender terminal 10 to the delivery management system 100, or may be transmitted from the e-trading system 200 to the delivery management system 100.

The terminal 10 of the recipient 21, that is, the recipient terminal 20 may connect to the e-trading system 200, may receive a list of goods (e.g., products to be sold) to be delivered, and may transmit information about goods (e.g., a product to purchase) to be received to the e-trading system 200, in response to an input from or a setting predefined by the recipient 21. Accordingly, the recipient 21 may purchase or receive donation of the delivery item. Also, depending on example embodiments, the recipient terminal 20 may directly connect to the delivery management system 100, may receive information about a current delivery status or an estimated delivery time from the delivery management system 100, or may transfer information about delivery completion to the delivery management system 100.

The sender terminal 10 and/or the recipient terminal 20 may be implemented using a smartphone, a desktop, and the like, which is similar to the aforementioned terminal 308 of the deliverer 300.

Hereinafter, the delivery management device 110 of the delivery management system 100 is further described with reference to FIG. 2. In the following, for clarity of description, description is made based on an example embodiment in which the delivery management system 100 includes a single delivery management device 110 and the single delivery management device 110 performs various operations or functions of the delivery management system 100. However, it does not imply that the delivery management system 100 includes only a single delivery management device 110. Depending on example embodiments, the delivery management system 100 may include a plurality of different delivery management devices and the plurality of different delivery management devices may perform a portion of or all of each operation, configuration, and function of the delivery management device 110, which is described below.

FIG. 2 is a block diagram illustrating an example embodiment of a delivery management device.

Referring to FIG. 2, the delivery management device 110 may include a processor 150. The processor 115 may control the overall operation of the delivery management device 110 and may also perform processing or control of various operations related to delivery. For example, the processor 115 may collect a variety of information related to delivery, may perform a predetermined determination or generate predetermined data based on the collected information, may manage the overall delivery based on the determination or the generated data, and/or may receive information or an instruction from the terminal 10, 20, 308 or the storage device 309 or transfer the information or the instruction to the terminal 10, 20, 308, or the storage device 309.

The processor 115 may be designed to perform a predetermined operation, determination, processing, and/or control operation by executing an application stored in a storage medium (not shown). Here, the application stored in the storage medium may be prepared by a designer and thereby stored, or may be acquired or updated through an electronic software distribution network accessible through a wired or wireless communication network.

The processor 115 may include, for example, a central processing unit (CPU), a micro controller unit (MCU), a micro processor (Micom), an application processor (AP), an electronic control unit (ECU), and/or other electronic devices capable of performing processing of various operations and generating a control signal. Such devices may be implemented using, for example, one or at least two semiconductor chips and related part.

According to an example embodiment, the processor 115 may include a delivery management unit 120, a controller 130, and an interfacer 140. They 120, 130, and 140 may be physically separate from each other, and/or may be logically separate from each other.

The delivery management unit 120 may perform various types of works required for managing and/or controlling delivery, such as, for example, collecting and processing at least one piece of information required for delivery, determining a delivery route, and/or performing various types of processing related to the deliverer 300.

According to an example embodiment, the delivery management unit 120 may include an information collection and processing unit 122, a delivery route management unit 124, a cost processing unit 126, and a deliverer management unit 128.

The information collection and processing unit 122 may collect necessary information and may classify/process the collected information to be an easily processible form.

For example, the information collection and processing unit 122 may collect and process data related to at least one of the sender 11, the recipient 12, and the deliverer 300. For example, the information collection and processing unit 122 may collect information about a location of at least one of the sender 11, the recipient 12, and the deliverer 300. Locations thereof (11, 12, 300) may include a predefined location, an existing location, and/or a real-time location.

Also, the information collection and processing unit 122 may collect environmental information related to delivery. The environmental information related to delivery may include, for example, information about the road itself (e.g., one-way traffic status, etc.), information about a road traffic condition (e.g., congestion, warning information, etc.), information related to weather, and/or public transportation (bus arrival time, subway arrival time, delay time, etc.), and the like. The information may also include previous information and may also include real-time information.

Information collected by the information collection and processing unit 122 may be mass data, that is, bigdata. In this case, the information collection and processing unit 122 may perform collecting and processing of information using various techniques or methods to process bigdata. Here, the bigdata may include mass information transmitted in real time from each of various participants (11, 21, 300) and/or acquired in real time through other Internet networks and the like. The bigdata may be represented as three V models, that is, features of volume (mass data), variety (various types of data), and velocity (speed of streaming data). Using such bigdata, prediction of necessary conditions, such as traffic volume, derivation of an optical route, and/or learning of an artificial intelligence (AI) algorithm in various forms, may be performed more appropriately and optimally.

The delivery route management unit 124 may optimize a delivery route of a delivery item. If at least one of the sender 11 and the recipient 12 selects a delivery method, the delivery route management unit 124 may derive an optimized delivery route according thereto. In detail, the delivery route management unit 124 may determine the optimal delivery route based on the information collected, classified, or processed by the information collection and processing unit 122. For example, the delivery route management unit 124 may predict a request of a user or a road traffic condition based on the aforementioned information and may retrieve and derive an optimal route based on a prediction result.

The optimal delivery route may be a route that uses a minimum amount of time, may be a route that uses minimum cost, or may be a route that is determined by considering both time and cost. In addition, the optimal delivery route may be a route that is separately predefined to be optimal by the user (e.g., the sender 11 or the recipient 12) or the designer. Also, the optimal delivery route may include only a single deliverer 300, or may also include a plurality of deliverers 300. That is, the delivery route management unit 124 may determine a delivery route using a single deliverer 300 (e.g., a single walking deliverer 304) such that the single deliverer 300 may perform delivery alone, or may determine the delivery route by combining the plurality of deliverers 300 (e.g., the delivery truck 301 and the walking deliverer 304) such that the plurality of deliverers 300 may sequentially deliver the delivery item.

According to an example embodiment, the delivery route management unit 124 may also use a machine learning process to derive the optimal route. Here, the machine learning process may use at least one of, for example, multilayer perceptron (MLN), a deep neural network (DNN), a convolutional neural network (CNN), a recurrent neural network (RNN), a convolutional recurrent neural network (CRNN), a deep belief network (DBN), and deep Q-network. In detail, the delivery route management unit 124 may predict road traffic conditions based on a machine learning process and may determine an optimal route based on a prediction result. In this case, the delivery route management unit 124 may determine an estimated amount of time required for delivery for each deliverer 300 based on the prediction result and may determine the optimal delivery route based on the determined estimated amount of time.

Also, the delivery route management unit 124 may manage communication between the terminal 308 of the deliverer 300 (e.g., a logistics company or an individual desiring to participate in delivery) and the storage device 309 based on the derived delivery route.

The cost processing unit 126 may process a cost processing and distribution issue about one or a plurality of deliverers 300 participating in delivery. If the plurality of deliverers 300 participates in the delivery, the cost processing unit 126 may determine the share to be paid to each deliverer 300 in the entire delivery cost. Therefore, the cost processing unit 126 may process how to distribute a delivery cost to each deliverer 300. According to an example embodiment, the cost processing unit 126 may also use a smart contract to process the share to be distributed to the plurality of deliverers 300. Here, the smart contract may be implemented based on blockchain technology.

The deliverer management unit 128 may select the deliverer 300 to participate in delivery or may process payment for them by managing the deliverers 300.

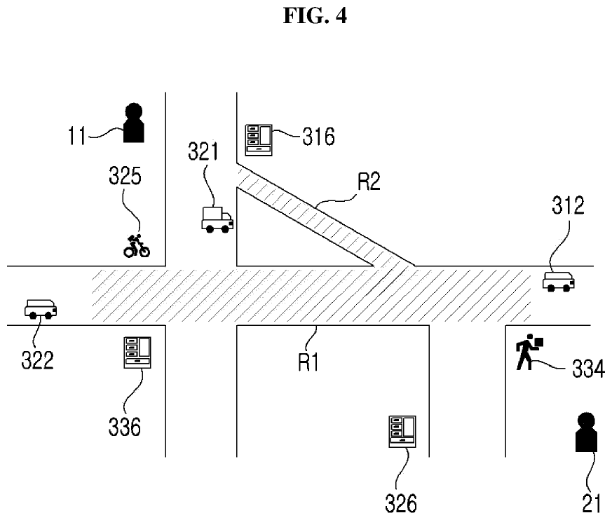

In detail, for example, the deliverer management unit 128 may distribute all of or a portion of the delivery to one or at least two specific deliverers 300 based on a determination result of the delivery route by the delivery route management unit 124. In this case, one or at least two deliverers 300 may be some deliverers 300 (e.g., 316, 321, and 334 of FIG. 4) selected from among the registered plurality of deliverers 300.

According to an example embodiment, the deliverer management unit 128 may be designed to split and distribute a delivery work to the plurality of deliverers 300 by employing a crowdsourcing method to achieve an optimal delivery. In the case of using the crowdsourcing method, it is possible to reduce investment on a logistics company and to acquire benefits, such as flexibility in supply and the multipurpose use of a specific asset, such as a vehicle.

Also, the deliverer management unit 128 may perform payment processing according to completion of the delivery work. In detail, for example, if the deliverer 300 having completed delivery inputs delivery completion to the deliverer terminal 308, the deliverer terminal 308 transmits the same to the delivery management device 110. When a signal for delivery completion is received from the deliverer terminal 308 and a contract condition is determined to have been achieved based on the received signal, the cost processing unit 126 processes payment for delivery to the deliverer 300. The payment may be made immediately after a predetermined amount of time elapses, or after delivery is completed. The payment for the delivery may be made through an account transfer and the like. The payment may be made using general real currency and/or digital currency (which may include virtual currency, such as cryptocurrency).

The controller 130 may be configured to manage the information collection and processing unit 122, the delivery route management unit 124, the cost processing unit 126, and/or the deliverer management unit 128 and to control communication therebetween. Also, the controller 130 may interconnect the delivery management unit 120 and the interfacer 140 such that information received from the sender terminal 10, the recipient terminal 20, the deliverer terminal 308, the storage device 309, and/or an external device (not shown, for example, a traffic condition information acquisition system) capable of providing a variety of information may be transferred to the delivery management unit 120, and/or such that each deliverer 300 may transmit information required for delivery (e.g., information about a next deliverer or information about a delivery location) or an instruction to the sender terminal 10, the recipient terminal 20, and/or the deliverer terminal 308. Here, the instruction or information required for delivery may be determined based on the determined optimal route.

The interfacer 140 may mediate exchange of information between the processor 115 and an external device (i.e., the sender terminal 10, the recipient terminal 20, the deliverer terminal 308, the storage device 309, and/or the external device capable of providing a variety of information). For example, the interfacer 140 may transmit information about a distribution status and information about a delivery route to the deliverer terminal 308 based on a delivery distribution result by the deliverer management unit 128. The interfacer 140 may be implemented in a form of a website. In this case, the sender terminal 10, the recipient terminal 20, and/or the deliverer terminal 308 may access the interfacer 140 using a general Internet browser, a hybrid app, and the like.

Hereinafter, an example embodiment of a process of selecting, by the delivery management system 100, an optimal delivery route is further described.

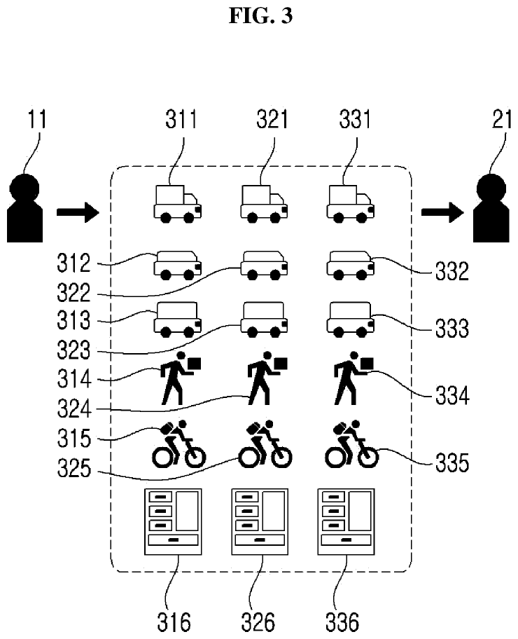

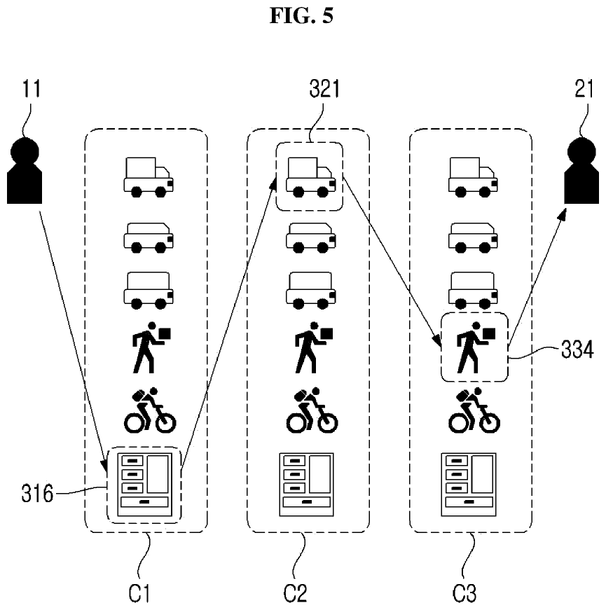

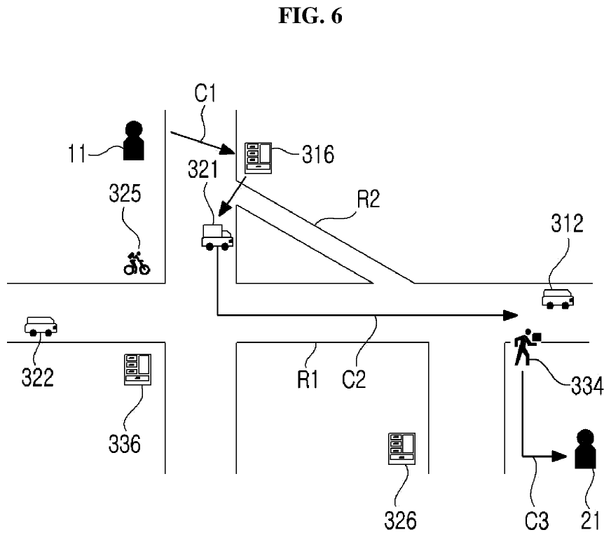

FIG. 3 is a first diagram describing a process of determining a delivery route by a delivery management system, FIG. 4 is a second diagram illustrating describing a process of determining a delivery route by a delivery management system, FIG. 5 is a first diagram illustrating an example embodiment of a delivery route determined by a delivery management system, and FIG. 6 is a second diagram illustrating an example embodiment of a delivery route determined by a delivery management system.

In response to a request from the recipient 21, the sender 11 may determine to deliver a delivery item and may transmit the same to the delivery management system 100. The delivery management system 100 may verify a sending location of the sender 11 and a reception location of the recipient 21 and may derive an optimized route. In this case, referring to FIGS. 3 and 4, an optimal route may be derived using a set of deliverers 300 (311 to 336) capable of participating in delivery. The set of deliverers 311 to 336 may include, for example, delivery trucks 311, 321, and 331, passenger vehicles 312, 322, and 332, unmanned vehicles 313, 323, and 333, walking deliverers 314, 324, and 334, bike deliverers 315, 325, and 335, and/or storage devices 316, 326, and 336. The optimal route may be determined based on a set of deliverers 311 to 336 capable of participating in the delivery.

In detail, referring to FIG. 4, the delivery management system 100 may periodically or aperiodically acquire/collect a variety of information for determining a route, such as, for example, a location of each of the storage devices 316, 326, and 336, a deliverer (e.g., the delivery truck 321, the passenger vehicles 312 and 322, the bike deliverer 325, and the walking deliverer 334) capable of participating in delivery, information about each type thereof 312, 321, 322, 325, and 334, location information thereof 312, 321, 322, 325, and 334, and/or traffic conditions of roads R1 and R2 through which delivery is performed. Such information may be collected in real time.

In a sequential manner, the delivery management system 100 may determine the optimal route based on acquired/collected information. In detail, the delivery management system 100 may determine one or at least two delivery routes by combining one or more storage devices 316, 326, and 336 and/or one or more deliverers 321, 322, 325, and 334 based on the collected information. In this case, referring to FIG. 5, one or at least two delivery routes may include one or a plurality of delivery stages C1, C2, and C3. Each of the delivery stages C1, C2, and C3 may be performed by a different deliverer (311 to 336). In a sequential manner, the delivery management system 100 may determine an optimal delivery route by selecting a single delivery route from among the determined single or at least two delivery routes.

Accordingly, referring to FIGS. 5 and 6, a delivery route from the sender 11 to the recipient 12 may be determined. For example, the delivery route may be determined such that the sender 11 stores a delivery item in the storage device 316 relatively close to the sender 11 (first stage, C1) and, in a sequential manner, the delivery truck 321 receives the delivery item of the storage device 316 and then delivers the delivery item (second stage, C2) and the delivery truck 321 transfers the delivery item to the walking deliverer 334 at a predefined point (third stage, C3), and the walking deliverer 334 transfers the delivery item to the final recipient 21. In addition thereto, a driving route of the delivery truck 321 may also be determined. For example, instead of a road (R2) that is a shortest distance, but is in a congested state, a bypass road (R1) having a smooth traffic condition may be determined as the driving route of the delivery truck 321.

If the delivery route is determined, the delivery management system 100 may provide the selected deliverers (i.e., the storage device 316, the delivery truck 321, and the walking deliverer 334) with a delivery instruction and information required for the deliverers (316, 321, and 334) to perform the delivery (e.g., a type of the delivery item, a password of the storage device 316, a reception location of the delivery item or a transfer location of the delivery item, etc.) and may instruct them to perform the delivery. In addition, the delivery management system 100 may also receive information about the delivery (e.g., information about a current location, a delivery completion status, etc.) from the selected deliverers (316, 321, and 334). The information about the delivery may be transferred to the deliverer (321 or 334) to perform the delivery sequentially through the terminal 308 of the deliverer (321 or 334). Also, the delivery management system 100 may also transfer information about the delivery to the sender 11 and/or the recipient 21 such that the sender 11 and/or the recipient 21 may verify a delivery status in real time. When the individual delivery stages (C1 to C3) are terminated or when the entire delivery is completed, the delivery management system 100 may pay the deliverers (316, 321, and 334) having participated in the delivery. In this case, as described above, smart contract technology based on blockchain technology may be employed and accordingly, each of the deliverers (316, 321, and 334) may receive the share for the delivery.

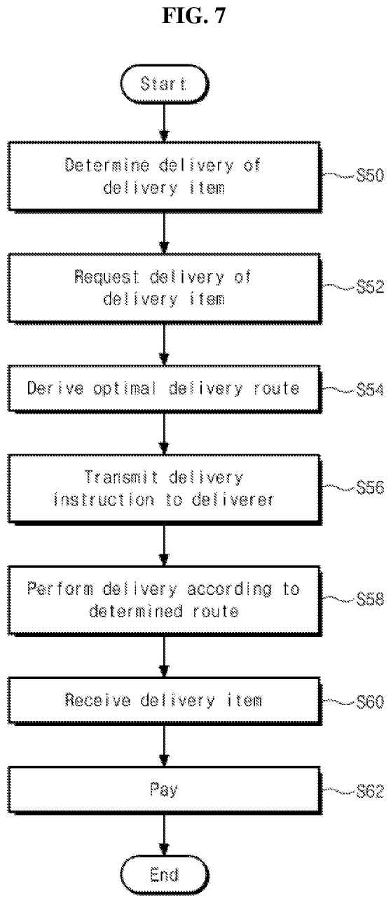

Hereinafter, an example embodiment of a delivery management method is described with reference to FIG. 7

FIG. 7 is a flowchart illustrating an example embodiment of a delivery management method.

Referring to FIG. 7, transfer of a delivery item may be determined based on intent of at least one of a sender and a recipient (S50), and delivery of the delivery item may be requested through a network accordingly (S52). In detail, for example, the recipient (e.g., a buyer) may determine purchase of a delivery item (e.g., a product) proposed by the sender (e.g., a seller) through an e-trading system, such as an online marketplace. A delivery method of the delivery item may be determined in a sequential manner. The delivery method may be determined in response to a selection from the recipient. Such determination may be transferred to a delivery management system through the online marketplace and/or may be directly transferred from the sender or the recipient to the delivery management system.

The delivery management system derives an optimal delivery route (S54). In detail, the delivery management system may collect information about a deliverer, the recipient and/or a deliverer and a variety of information required for delivery and may determine a delivery route based on the collected information. The variety of information required for delivery may be acquired before receiving a delivery request and/or may be acquired after receiving the delivery request. The information required for delivery may include, for example, information about a road or a traffic condition by which delivery is to be performed, weather, and/or information related to public transportation. Deriving of the optimal delivery route may be performed based on the aforementioned machine learning process.

All of or a portion of the optimal delivery route may be distributed to each of at least one deliverer. That is, the delivery route may be constructed through a combination of one or at least two deliverers. In this case, distribution processing of the delivery route may be implemented based on crowdsourcing.

If the optimal delivery route is derived, the delivery management system may transmit a delivery instruction to a terminal of each deliverer included in the optimal delivery route such that each deliverer may perform the delivery (S56). In this case, information about the delivery item, a reception location of the delivery item, an arrival destination of the delivery item, and/or a physical transfer route of the delivery item may also be transferred to each deliverer.

The one or at least two deliverers may perform deliver as instructed such that the delivery item may be delivered according to the determined optimal route (S58). If a plurality of deliverers included in a route, each deliverer performs the delivery of the delivery item by sequentially delivering the delivery item.

Finally, the recipient receives the delivery item from a final deliverer (S60). Accordingly, the delivery is completed.

According to an example embodiment, once the delivery is completed, the one or at least two deliverers having participated in the delivery may be paid for the delivery (S62). In this case, distribution of delivery cost may be processed using a blockchain-based smart contract. Depending on example embodiments, every time delivery by each deliverer is terminated, each deliverer may be paid. The payment may be made using real currency or digital currency.

A portion of or all of the delivery management method according to the example embodiments may be implemented in a form of a program executable by a computer apparatus. Here, the program may include, alone or in combination with program instructions, data files, data structures, and the like. The program may be designed and manufactured using a machine language code or a higher level code. The program may be specially designed to implement the aforementioned method and may be implemented using functions or definitions well-known and available to those skilled in the computer software arts. Also, a computer apparatus may include a processor, a memory, and the like, to implement functions of the program, and, if necessary, may further include a communication apparatus.

The program for implementing the delivery management method may be recorded in non-transitory computer-readable media. Examples of the media may include magnetic disc storage media such as hard discs and floppy discs; optical media such as magnetic tapes, compact discs, and DVDs; magneto-optical media such as floptical discs; and various types of hardware devices that are specially configured to store a specific program executed in response to call of a computer, such as semiconductor storage devices, for example, read only memory (ROM), random access memory (RAM), flash memory, and the like.

Although a number of example embodiments regarding the delivery system, the delivery management system, the delivery management device, and the delivery management method have been described above, the delivery management system, the delivery management device, and the delivery management method are not limited thereto. Various apparatuses or methods achieved by one of ordinary skill in the art through alterations and modifications based on the example embodiments may be determined as the aforementioned delivery system, delivery management system, delivery management device, and delivery management method. For example, although the described techniques are performed in different order and/or although components in a described system, architecture, apparatus, or circuit are combined in a different manner or replaced or supplemented by other components or their equivalents, they may be an example embodiment of the aforementioned delivery system, delivery management system, delivery management device and delivery management method.

What is claimed is:

1. A delivery system comprising:
a plurality of deliverer terminals corresponding to a plurality of deliverers, respectively; and
a delivery management system configured to collect information required for delivery and to determine an optimal route by which a delivery item is to be delivered by combining at least one deliverer among the plurality of deliverers based on the information required for delivery.

2. The delivery system of claim 1, wherein the delivery management system is configured to transmit a delivery instruction to at least one of the plurality of deliverer terminals according to the optimal route.

3. The delivery system of claim 1, wherein the information required for delivery comprises at least one of information about a sender, information about a recipient, and information about the plurality of deliverers, and environmental information related to delivery.

4. The delivery system of claim 3, wherein the delivery management system is configured to determine the optimal route based on a predicted traffic condition using a machine learning process.

5. The delivery system of claim 1, wherein the delivery management system is configured to make a payment for the at least one deliverer.

6. The delivery system of claim 5, wherein the delivery management system is configured to determine cost for the at least one deliverer using a blockchain-based smart contract.

7. The delivery system of claim 1, wherein the delivery management system is configured to distribute a delivery route between deliverers using a crowdsourcing model.

8. The delivery system of claim 1, further comprising at least one of:
a terminal of a sender configured to send a delivery item;
a terminal of a recipient configured to receive the delivery item; and
an electronic trading (e-trading) system configured to connect to at least one of the terminal of the sender and the terminal of the recipient and to determine a delivery item to be delivered by the deliverer.

9. The delivery system of claim 1, wherein the delivery management system comprises one or at least two delivery management devices.

10. A delivery management system comprising:
an information collection and processing unit configured to collect information required for delivery in volume;
a deliverer management unit configured to manage a plurality of deliverers; and
a delivery route management unit configured to determine an optimal delivery route by combining at least one deliverer among the plurality of deliverers based on the information collected by the information collection and processing unit.

11. The delivery management system of claim 10, further comprising:
a cost processing unit configured to determine cost to be paid to each of at least one deliverer included in the delivery route.

12. The delivery management system of claim 11, wherein the cost processing unit is configured to determine cost to be paid to the at least one deliverer using a blockchain-based smart contract.

13. The delivery management system of claim 10, wherein the delivery route management unit is configured to determine an optimal route based on a predicted traffic condition using a machine learning process.

14. The delivery management system of claim 10, wherein the deliverer management unit is configured to distribute, to at least one deliverer, a delivery according to an optimal route using a crowdsourcing method.

15. The delivery management system of claim 10, wherein the deliverer management unit is configured to process a payment according to delivery to the deliverer in response to receiving a signal about a delivery work completion from a terminal of the deliverer.

16. A delivery management device comprising:
an information collection and processing unit configured to collect information required for delivery in volume;
a deliverer management unit configured to manage a plurality of deliverers; and
a delivery route management unit configured to determine an optimal delivery route by combining at least one deliverer among the plurality of deliverers.

17. A delivery management method comprising:
receiving a delivery request;
deriving an optimal delivery route in response to the delivery request;
distributing a delivery route to at least one deliverer according to the derived optimal delivery route; and
transferring a delivery instruction to a terminal of the at least one deliverer.

18. The delivery management method of claim 17, wherein the deriving of the optimal delivery route in response to the delivery request comprises:
predicting a traffic condition using a machine learning process; and
determining an optimal route based on the predicted traffic condition.

19. The delivery management method of claim 17, further comprising:
making a payment for the at least one deliverer.

20. The delivery management method of claim 19, further comprising:
determining cost for the at least one deliverer using a blockchain-based smart contract.
